(19) United States
(12) Patent Application Publication
(10) Pub. No.: US 2026/0003427 A1
(43) Pub. Date: Jan. 1, 2026

(54) RENDERING IMAGES WITH RECONSTRUCTION OF FOVEATED RESOLUTION DISPLAYS

(71) Applicant: Meta Platforms Technologies, LLC, Menlo Park, CA (US)

(72) Inventors: Misael Perez Martinez, Kirkland, WA (US); Yongman Lee, Sunnyvale, CA (US); Wonjae Choi, San Jose, CA (US); Dustin Wai, Sunnyvale, CA (US)

(21) Appl. No.: 19/050,819

(22) Filed: Feb. 11, 2025

Related U.S. Application Data
(60) Provisional application No. 63/665,043, filed on Jun. 27, 2024.

(51) Int. Cl. G06F 3/01; G06T 3/40; G06T 11/00

(52) U.S. Cl. CPC G06F 3/013; G06T 3/40; G06T 11/001; G06T 2210/21

(57) ABSTRACT

Methods, systems, and storage media for rendering images are disclosed. Exemplary implementations may: receive object(s) in an area of interest of a mixed reality environment; identify a foveated region; generate a grid in proximity to the foveated region; determine coordinate(s), wherein each coordinate is defined based on a spatial orientation in the grid; assign the coordinate(s) to the object(s) in the area of interest; compress a portion of the grid external to the foveated region and data associated with the object(s) covered by the portion of the grid external to the foveated region; implement a chromatic aberration correction (CAC) protocol to the compressed coordinate data and compressed object data; transmit the foveated region, compressed coordinate data and object data; decompress the compressed coordinate data and object data; and render an environment associated with the area of interest using the foveated image and object data external to the foveated image.

### CROSS REFERENCE TO RELATED APPLICATIONS

This present application claims the benefit of priority under 35 U.S.C. § 119 (e) to U.S. Provisional Application No. 63/665,043, filed Jun. 27, 2024, the disclosure of which is hereby incorporated by reference in its entirety for all purposes.

### TECHNICAL FIELD

The present disclosure generally relates to rendering images, and more particularly to reconstruction of foveated resolution displays.

### BACKGROUND

In the field of mixed reality users may interact with simulated environments that can replicate real-world or fantastical scenarios. These simulated environments may include a variety of objects with different textures and shapes, aiming to provide an immersive experience. The visual realism in such settings may be crucial for applications spanning entertainment, military, medical, and process manufacturing simulations.

### BRIEF SUMMARY

The subject disclosure provides for systems and methods for rendering images. A user is allowed to interact with a mixed reality environment with enhanced visual realism and optimized computational resources. For example, the user's point of focus within the environment may be rendered in high resolution while peripheral regions are displayed at a reduced resolution, thereby managing system demands efficiently.

One aspect of the present disclosure relates to a method for rendering an image. The method may include receiving a plurality of objects in an area of interest of a mixed reality environment. The method may include identifying a foveated region. The method may include generating a grid in proximity to the foveated region, wherein the grid comprises a plurality of intersecting vertical and horizontal lines. The method may include determining a plurality of coordinates, wherein each coordinate of the plurality of coordinates is defined based on a spatial orientation in the grid. The method may include assigning the plurality of coordinates to the plurality of objects in the area of interest. The method may include compressing a portion of the grid external to the foveated region and data associated with the plurality of objects covered by the portion of the grid external to the foveated region. The method may include implementing a chromatic aberration correction protocol to the compressed coordinate data and compressed object data. The chromatic aberration correction may separate to color components into size ratios in relation to the chromatic frequency associated with the respective color component. The method may include transmitting the foveated region, compressed coordinate data and compressed object data. The method may include decompressing the compressed coordinate data and compressed object data. The method may include rendering an environment associated with the area of interest using the foveated image and object data external to the foveated image.

Another aspect of the present disclosure relates to a system configured for rendering an image. The system may include a non-transient computer-readable storage medium having executable instructions embodied thereon. The system may include one or more hardware processors configured to execute the instructions. The processor(s) may execute the instructions to receive a plurality of objects in an area of interest of a mixed environment. The processor(s) may execute the instructions to identify a foveated region. The processor(s) may execute the instructions to generate a grid in proximity to the foveated region, wherein the grid comprises a plurality of intersecting vertical and horizontal lines. The processor(s) may execute the instructions to determine a plurality of coordinates, wherein each coordinate of the plurality of coordinates is defined based on a spatial orientation in the grid. The processor(s) may execute the instructions to assign the plurality of coordinates to the plurality of objects in the area of interest. The processor(s) may execute the instructions to compress a portion of the grid external to the foveated region and data associated with the plurality of objects covered by the portion of the grid external to the foveated region. The processor(s) may execute the instructions to implement a chromatic aberration correction protocol to the compressed coordinate data and compressed object data. The chromatic aberration correction may separate to color components into size ratios in relation to the chromatic frequency associated with the respective color component. The processor(s) may execute the instructions to transmit the foveated region, compressed coordinate data and compressed object data. The processor(s) may execute the instructions to decompress the compressed coordinate data and compressed object data. The processor(s) may execute the instructions to render an environment associated with the area of interest using the foveated image and object data external to the foveated image.

Yet another aspect of the present disclosure relates to a system configured for rendering an image. The system may include means for receiving a plurality of objects in an area of interest of a mixed reality environment. The system may include means for identifying a foveated region. The system may include means for generating a grid in proximity to the foveated region, wherein the grid comprises a plurality of intersecting vertical and horizontal lines. The system may include means for determining a plurality of coordinates, wherein each coordinate of the plurality of coordinates is defined based on a spatial orientation in the grid. The system may include means for assigning the plurality of coordinates to the plurality of objects in the area of interest. The system may include means for compressing a portion of the grid external to the foveated region and data associated with the plurality of objects covered by the portion of the grid external to the foveated region. The system may include means for implementing a chromatic aberration correction protocol to the compressed coordinate data and compressed object data. The chromatic aberration correction may separate to color components into size ratios in relation to the chromatic frequency associated with the respective color component. The system may include means for transmitting the foveated region, compressed coordinate data and compressed object data. The system may include means for decompressing the compressed coordinate data and compressed object data. The system may include means for rendering an environment associated with the area of interest using the foveated image and object data external to the foveated image.

Still another aspect of the present disclosure relates to a non-transient computer-readable storage medium having instructions embodied thereon, the instructions being executable by one or more processors to perform a method for rendering an image in a mixed reality environment. The method may include receiving a plurality of objects in an area of interest of the mixed reality environment. The method may include identifying a foveated region. The method may include generating a grid in proximity to the foveated region, wherein the grid comprises a plurality of intersecting vertical and horizontal lines. The method may include determining a plurality of coordinates, wherein each coordinate of the plurality of coordinates is defined based on a spatial orientation in the grid. The method may include assigning the plurality of coordinates to the plurality of objects in the area of interest. The method may include compressing a portion of the grid external to the foveated region and data associated with the plurality of objects covered by the portion of the grid external to the foveated region. The method may include implementing a chromatic aberration correction protocol to the compressed coordinate data and compressed object data. The chromatic aberration correction may separate to color components into size ratios in relation to the chromatic frequency associated with the respective color component. The method may include transmitting the foveated region, compressed coordinate data, and compressed object data. The method may include decompressing the compressed coordinate data and compressed object data. The method may include rendering an environment associated with the area of interest using the foveated image and object data external to the foveated image.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a block diagram illustrating an overview of an environment in which some implementations of the disclosed technology can operate.

FIG. 2 illustrates a process of identifying and processing a region for foveated resolution display, in accordance with one or more implementations.

FIG. 3 illustrates overlaying a grid mesh to a foveated region, in accordance with one or more implementations.

FIG. 4 illustrates a centralized view of the grid mesh overlayed on the foveated region of FIG. 3, in accordance with one or more implementations.

FIG. 5 illustrates a chromatic aberration correction which supports techniques for rendering foveated resolution in virtual environments in accordance with various aspects of the present disclosure.

FIG. 6 illustrates a graph of modeling used to execute the chromatic aberration correction, in accordance with one or more implementations.

FIG. 7 illustrates a process of expanding compressed data in a foveated region expander, in accordance with one or more implementations.

FIG. 8 illustrates a diagram of the impact of an accumulator for expansion along a horizontal axis, in accordance with one or more implementations.

FIG. 9 illustrates a diagram of the impact of expansion along the vertical axis, in accordance with one or more implementations.

FIG. 10 illustrates a system configured for rendering an image, in accordance with one or more implementations.

FIG. 11 illustrates an example flow diagram for rendering an image, according to certain aspects of the disclosure.

FIG. 12 is a block diagram illustrating an example computer system (e.g., representing both client and server) with which aspects of the subject technology can be implemented.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

In the following detailed description, numerous specific details are set forth to provide a full understanding of the present disclosure. It will be apparent, however, to one ordinarily skilled in the art, that the embodiments of the present disclosure may be practiced without some of these specific details. In other instances, well-known structures and techniques have not been shown in detail so as not to obscure the disclosure.

The term “mixed reality” or “MR” as used herein refers to a form of reality that has been adjusted in some manner before presentation to a user, which may include, e.g., virtual reality (VR), augmented reality (AR), extended reality (XR), hybrid reality, or some combination and/or derivatives thereof. Mixed reality content may include completely generated content or generated content combined with captured content (e.g., real-world photographs). The mixed reality content may include video, audio, haptic feedback, or some combination thereof, any of which may be presented in a single channel or in multiple channels (such as stereo video that produces a three-dimensional (3D) effect to the viewer). Additionally, in some embodiments, mixed reality may be associated with applications, products, accessories, services, or some combination thereof, that are, e.g., used to interact with content in an immersive application. The mixed reality system that provides the mixed reality content may be implemented on various platforms, including a head-mounted display (HMD) connected to a server, a host computer system, a standalone HMD, a mobile device or computing system, a “cave” environment or other projection system, or any other hardware platform capable of providing mixed reality content to one or more viewers. Mixed reality may be equivalently referred to herein as “artificial reality.”

“Virtual reality” or “VR,” as used herein, refers to an immersive experience where a user's visual input is controlled by a computing system. “Augmented reality” or “AR” as used herein refers to systems where a user views images of the real-world after they have passed through a computing system. For example, a tablet with a camera on the back can capture images of the real-world and then display the images on the screen on the opposite side of the tablet from the camera. The tablet can process and adjust or “augment” the images as they pass through the system, such as by adding virtual objects. AR also refers to systems where light entering a user's eye is partially generated by a computing system and partially composes light reflected off objects in the real-world. For example, an AR headset could be shaped as a pair of glasses with a pass-through display, which allows light from the real-world to pass through a waveguide that simultaneously emits light from a projector in the AR headset, allowing the AR headset to present virtual objects intermixed with the real objects the user can see. The AR headset may be a block-light headset with video pass-through. “Mixed reality” or “MR,” as used herein, refers to any of VR, AR, XR, or any combination or hybrid thereof.

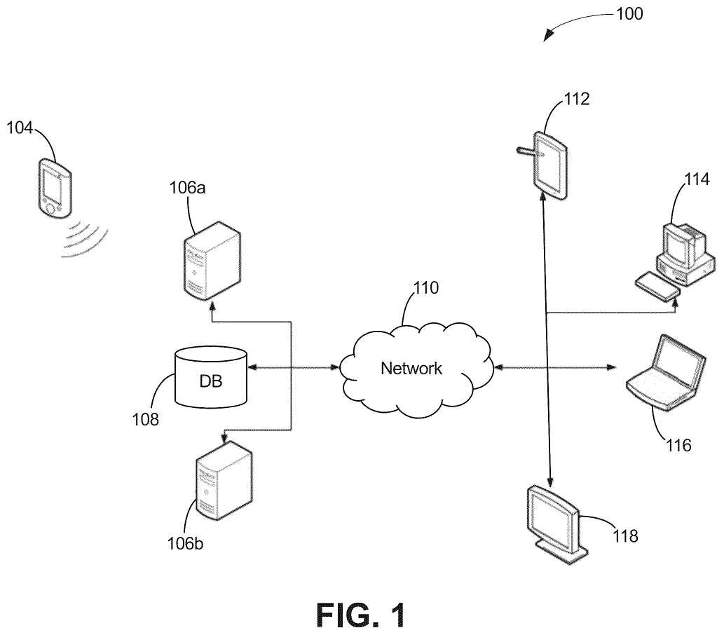

FIG. 1 is a block diagram illustrating an overview of an environment 100 in which some implementations of the disclosed technology can operate. The environment 100 can include one or more client computing devices, mobile device 104, tablet 112, personal computer 114, laptop 116, desktop 118, and/or the like. Client devices may communicate wirelessly via the network 110. The client computing devices can operate in a networked environment using logical connections through network 110 to one or more remote computers, such as server computing devices. In some implementations, the mobile device 104 may include a head mounted display (HMD) configured for presenting AR and/or VR content to a user wearing the device.

In some implementations, the environment 100 may include a server such as an edge server which receives client requests and coordinates fulfillment of those requests through other servers. The server may include the server computing devices 106a-106b, which may logically form a single server. Alternatively, the server computing devices 106a-106b may each be a distributed computing environment encompassing multiple computing devices located at the same or at geographically disparate physical locations. The client computing devices and server computing devices 106a-106b can each act as a server or client to other server/client device(s). The server computing devices 106a-106b can connect to a database 108 or can comprise its own memory. Each server computing devices 106a-106b can correspond to a group of servers, and each of these servers can share a database 108 or can have their own database 108. The database 108 may logically form a single unit or may be part of a distributed computing environment encompassing multiple computing devices that are located within their corresponding server, located at the same, or located at geographically disparate physical locations.

The network 110 can be a local area network (LAN), a wide area network (WAN), a mesh network, a hybrid network, or other wired or wireless networks. The network 110 may be the Internet or some other public or private network. Client computing devices can be connected to network 110 through a network interface, such as by wired or wireless communication. The connections can be any kind of local, wide area, wired, or wireless network, including the network 110 or a separate public or private network.

In some examples, the challenge in virtual environments is to render images in a way that may align with the human visual system's varying acuity while optimizing computational resources. Existing techniques may struggle to balance the need for high-resolution imagery where the user is looking with the less detailed peripheral vision. Additionally, these techniques may encounter difficulties with color distortion, particularly when compressing and decompressing image data for the peripheral regions. This distortion may result from chromatic aberration, where colors separate due to their different wavelengths, leading to a less immersive and realistic experience. Furthermore, the process of scaling and aligning pixels during rendering may introduce rounding errors, which degrade image quality. There is a need for an improved method that may address these issues, reduce system demands, and enhance the overall user experience in virtual environments.

The subject disclosure provides for systems and methods for rendering images. A user is allowed to interact with a mixed reality environment with enhanced visual realism and optimized computational resources. For example, the user's point of focus within the environment may be rendered in high resolution while peripheral regions are displayed at a reduced resolution, thereby managing system demands efficiently. In certain aspects, safety and privacy protocols are implemented so that the user understands user eye data is obtained by the system. The user is informed in advance of the purpose for obtaining of the eye data, and may at any time opt out of the eye data being obtained. In certain aspects, the user may delete any past eye data stored by the system. Users who proceed with using the system may be notified that respective eye-movement data is being obtained for the purpose of determining pupil location as a representation of focusing direction of the user's eyes to more efficiently generate a foveated view in that respective direction.

Implementations described herein address the aforementioned shortcomings and other shortcomings by providing a method for rendering images in mixed reality environments to enhance visual realism while optimizing system resources. The method may involve generating a grid in proximity to a foveated region, which corresponds to the user's current point of focus within the virtual environment. This grid may serve as a framework for managing the resolution of the display, allowing for high-resolution rendering in the foveated region and reduced resolution outside of it. By compressing the data associated with the peripheral regions of the grid, some implementations may minimize the computational load and power consumption of the graphics processing unit and system on chip.

To address the issue of color fidelity, some implementations may incorporate a chromatic aberration correction protocol during the decompression phase. This protocol may ensure that the color components are accurately scaled and aligned, compensating for the differences in wavelength that can cause color distortion. The method may employ discrete subpixel scaling within the grid to fine-tune the correction process, and may utilize accumulators to mitigate rounding errors that may occur during the expansion of compressed data. The result may be a rendered environment that maintains color accuracy and visual quality across the entire field of view, providing users with a more immersive and realistic virtual experience. This innovative approach to foveated rendering not only may improve the visual output but also may contribute to the overall efficiency and performance of mixed reality systems.

According to some implementations, a system may execute a method for rendering images within a mixed reality environment. This system may identify a specific area within the user's view that requires higher detail, known as the foveated region. Surrounding this area, the system may generate a grid composed of intersecting lines both vertical and horizontal in orientation. This grid may serve as a reference for determining multiple coordinates that correspond to specific locations within the grid, allowing for precise placement and tracking of objects in the environment.

Objects within the user's field of view may be assigned to these coordinates, ensuring that their position and data are accurately tracked. For areas outside the foveated region, the system may compress the data to reduce the volume of information that needs to be processed. This compressed data, along with the foveated region data, may then be transmitted within the system's components.

Upon receipt of this data, the system may decompress the coordinate and object data in preparation for rendering. During this decompression, the system may implement a color correction process to address any potential color distortions that could occur due to the compression and decompression processes. This process may involve separating color components into size ratios that correspond to the frequency of each color, ensuring color fidelity.

The system may utilize discrete subpixel scaling, which allows for the evaluation of each subgrid within the overall grid to further reduce errors in color and resolution. To maintain the integrity of the visual data, the system may employ accumulators at the ends of zones within the grid. These accumulators may help to prevent rounding errors during the decompression process.

The system may render the environment associated with the user's area of interest, incorporating both the high-detail foveated image and the data from outside the foveated region. This rendering may take into account the corrected and decompressed data to provide a visually coherent and realistic experience within the mixed reality environment.

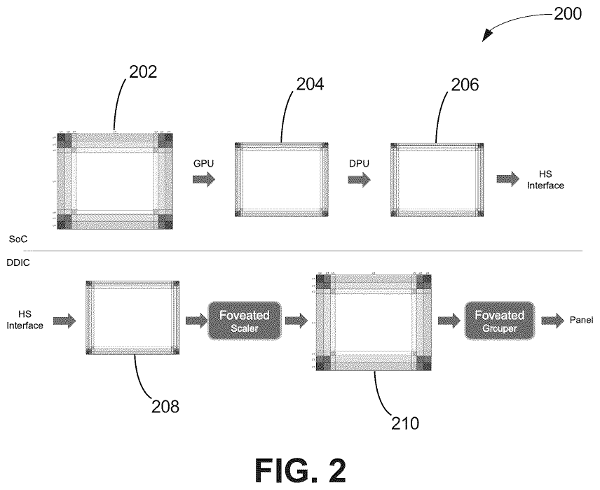

FIG. 2 illustrates a process 200 of identifying and processing a region for foveated resolution display, in accordance with one or more implementations. An MR system (e.g., as may be provided by server computing devices 106a-106b in FIG. 1) may comprise an eye tracking component in a headset or HMD. As the user moves their eyes to view different regions of the environment, their eyes will see different portions of the environment. In FIG. 2, the foveated region of graphical data 202 is initially defined by generating a mesh grid by the system of chip (Soc). A GPU may process the graphical data 202 for rendering in a virtual environment as graphical data 204. The GPU may be responsible for generating the visual content that users experience in a mixed reality setting. A DPU may may process graphical data 204, handling display protocols, into graphical data 206. The DPU may serve as a bridge between the processing units and the display unit. The DPU may manage the timing and format of the data being sent to a panel. The DPU may coordinate with the GPU to synchronize the graphical data 206 with appropriate display refresh rates. A HS interface may facilitate high-speed data transmission of graphical data 206. The coordinates of the grid and the representative elements of the grid are stored, compressed and transmitted to a display driver integrated circuit (DDIC).

The DDIC may expand the graphical data 206 into graphical data 208 as a part of the rendering using the grid coordinates associated with the mesh as a template. A foveated scaler may adjust the resolution of graphical data 208 within the foveated region, yielding graphical data 210. The foveated scaler may selectively increase the resolution in areas where the user's gaze is focused. The foveated scaler may dynamically alter the resolution based on eye-tracking data. The foveated scaler may work to maintain the visual quality in the foveated region while conserving processing resources. The foveated grouper may organize data in graphical data 210 related to the foveated region for efficient processing. The foveated grouper may categorize visual elements based on their location within the foveated region. Once completely rendered, the image is exported for view to a panel. The panel may display the rendered images to the user in the virtual environment.

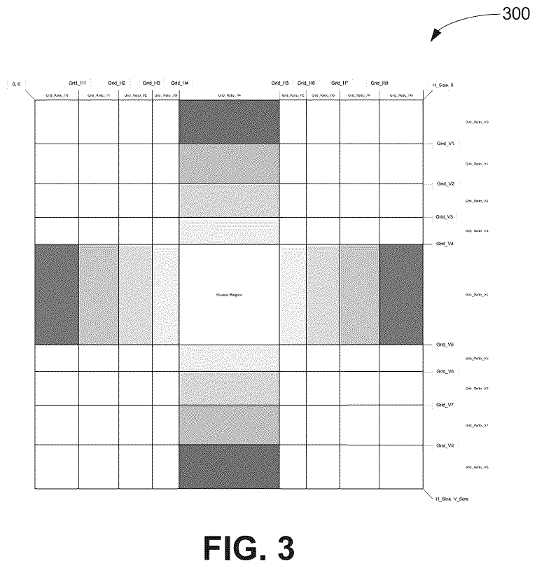

FIG. 3 illustrates overlaying a grid mesh 300 to a foveated region, in accordance with one or more implementations. The grid mesh 300 can be defined and can identify the elements in view, wherein the mesh is arranged in an arrangement of vertical and horizontal axes. For example, the grid can be configured with up to 81 grids with dedicated duplication/interpolation parameters per color. The mesh can also comprise 17-bits horizontal and vertical accumulators to maximize pre/post scaled pixel alignment precision without force alignment reset. In a further aspect, various ratios linear to vertical scaling can be used such as 1:1, 1:2, 1:3 and 1:4 duplication independently in both horizontal and vertical directions. In yet another aspect, 1 to 0.993˜4.028 linear scaling independently can be implemented in both horizontal and vertical directions.

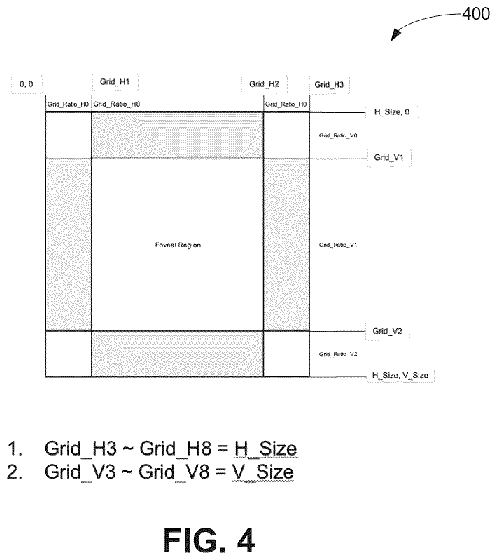

FIG. 4 illustrates a centralized view 400 of the grid mesh 300 overlayed on the foveated region of FIG. 3, in accordance with one or more implementations. In some implementations, the grid mesh 300 may be utilized to define coordinates for objects external to the foveated region, where the elements can be subsequently compressed. The grid mesh 300 may facilitate the decompression of data with respect to the coordinates of the grid and apply models to reduce errors, providing a visual representation in the VR environment. The grid mesh 300 may interact with a chromatic aberration correction protocol during the decompression process, where discrete subpixel scaling may be applied to each color component to correct for frequency-based distortions. Accumulators may be implemented at the ends of zones within the grid mesh 300 to avoid rounding errors that may occur during expansion, ensuring the integrity of the visual elements in the rendered environment.

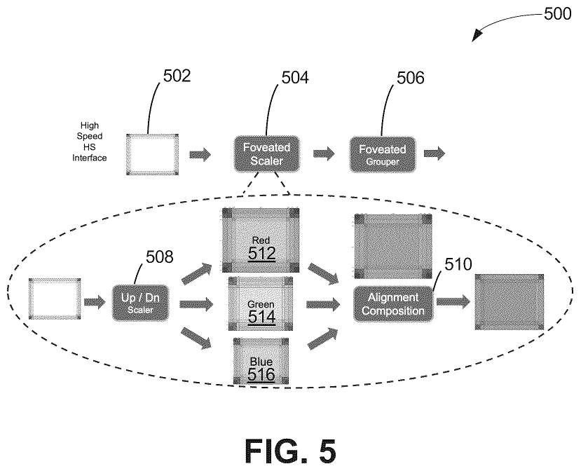

FIG. 5 illustrates a chromatic aberration correction 500 which supports techniques for rendering foveated resolution in virtual environments in accordance with various aspects of the present disclosure. As depicted in FIG. 5, the chromatic aberration correction 500 may include one or more of a high speed HS interface 502, a foveated scaler 504, a foveated grouper 506, an up/down scaler 508, an alignment composition 510, a red component 512, a green component 514, a blue component 516, and/or other components.

The high speed HS interface 502 may serve as the communication link for data transfer within the color separation diagram. In some implementations, the high speed HS interface 502 may be the same as or similar to the HS interface 208, as described herein.

The foveated scaler 504 may be responsible for adjusting the resolution of the foveated region. In some implementations, the foveated scaler 504 may be the same as or similar to the foveated scaler, as depicted in FIG. 2. The foveated grouper 506 may organize data related to the foveated region for processing. In some implementations, the foveated grouper 506 may be the same as or similar to the foveated grouper, as depicted in FIG. 2.

The up/down scaler 508 may modify the scale of image data in both upward and downward directions. The up/down scaler 508 may adjust the size of image elements to fit the display requirements of the virtual environment. The up/down scaler 508 may receive data from the foveated grouper 506 that has been pre-organized for scaling. In some implementations, the up/down scaler 508 may be capable of dynamically altering the scale of different image areas based on the current needs of the display system.

The alignment composition 510 may align the color components post scaling. The red component 512 may represent the red color component in the color separation process. In some implementations, the red component 512 may undergo individual scaling by the up/down scaler 508 before being aligned with the green component 514 and blue component 516 components. The green component 514 may represent the green color component in the color separation process. In some implementations, the green component 514 may be scaled separately to ensure that its intensity and hue are accurately represented in the final image. The blue component 516 may represent the blue color component in the color separation process. In some implementations, the blue component 516 may be individually adjusted in scale by the up/down scaler 508 to match the resolution and alignment with the red component 512 and green component 514 components.

The alignment composition 510 may ensure that the red component 512, green component 514, and blue component 516 components are correctly positioned relative to each other after scaling operations. The alignment composition 510 may receive scaled data from the up/down scaler 508 and perform the necessary adjustments to maintain image integrity. In some implementations, the alignment composition 510 may use reference points or markers within the image data to achieve precise alignment of the color components.

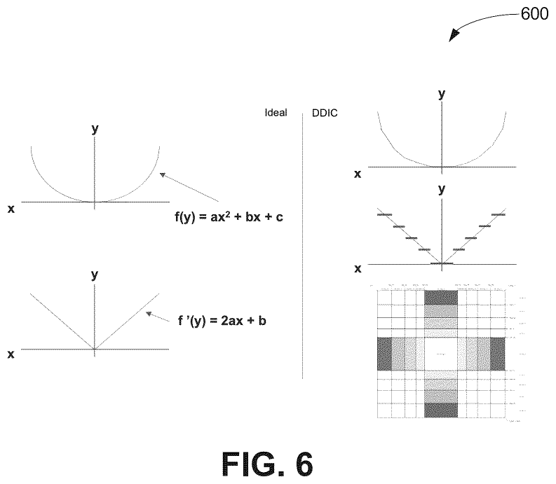

FIG. 6 illustrates a graph 600 of modeling used to execute the chromatic aberration correction, in accordance with one or more implementations. The graph may represent the comparison between ideal mathematical functions and their corresponding representations after processing by a DDIC.

The left side of the graph may depict the ideal mathematical functions. The top-left sub-graph may show a parabolic function represented by the equation (f(y)=ax\hat{ }2+bx+c). The axes may be labeled as ‘x’ and ‘y’, with the ‘x’ axis representing the horizontal component and the ‘y’ axis representing the vertical component. The scale may be linear, with equal intervals along both axes.

The bottom-left sub-graph may illustrate the derivative of the parabolic function, represented by the equation (f′(y)=2ax+b). Similar to the top-left sub-graph, the axes may be labeled ‘x’ and ‘y’, with a linear scale.

The right side of the graph may depict the corresponding functions after processing by the DDIC. The top-right sub-graph may show the processed parabolic function, which may appear distorted compared to the ideal function. The axes may be labeled ‘x’ and ‘y’, with the same linear scale as the ideal function for comparison purposes.

The bottom-right sub-graph may illustrate the processed derivative function, which may also appear distorted. The axes may be labeled ‘x’ and ‘y’, maintaining the same linear scale.

Additionally, the bottom-right corner of the graph may include a grid representation. This grid may depict the arrangement of pixels and their coordinates, highlighting the impact of the DDIC processing on pixel expansion. The grid may consist of intersecting vertical and horizontal lines, with specific regions marked to indicate areas of interest.

The graph 600 may provide a visual representation of how the DDIC processing affects the ideal mathematical functions, demonstrating the differences in pixel expansion and alignment. This comparison may be relevant to understanding the impact of the DDIC on image rendering in a mixed reality environment.

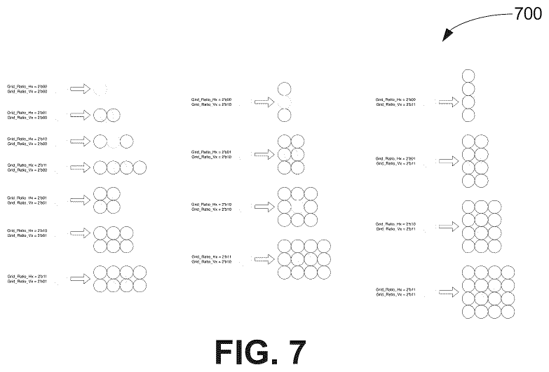

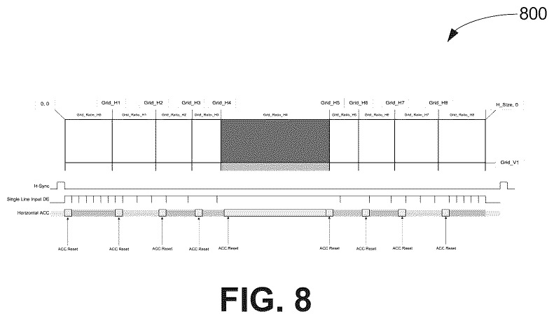

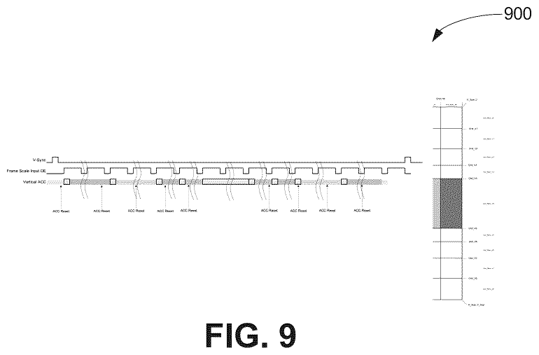

FIG. 7 illustrates a process 700 of expanding compressed data in a foveated region expander, in accordance with one or more implementations. FIG. 8 illustrates a diagram 800 of the impact of an accumulator for expansion along a horizontal axis, in accordance with one or more implementations. FIG. 9 illustrates a diagram 900 of the impact of expansion along the vertical axis, in accordance with one or more implementations.

The disclosed system(s) address a problem in traditional image rendering techniques tied to computer technology, namely, the technical problem of managing high-resolution rendering in a user's foveated region while reducing resolution in peripheral vision to optimize system resources. The disclosed system solves this technical problem by providing a solution also rooted in computer technology, namely, by providing for reconstruction of foveated resolution displays. The disclosed subject technology further provides improvements to the functioning of the computer itself because it improves processing and efficiency in rendering images.

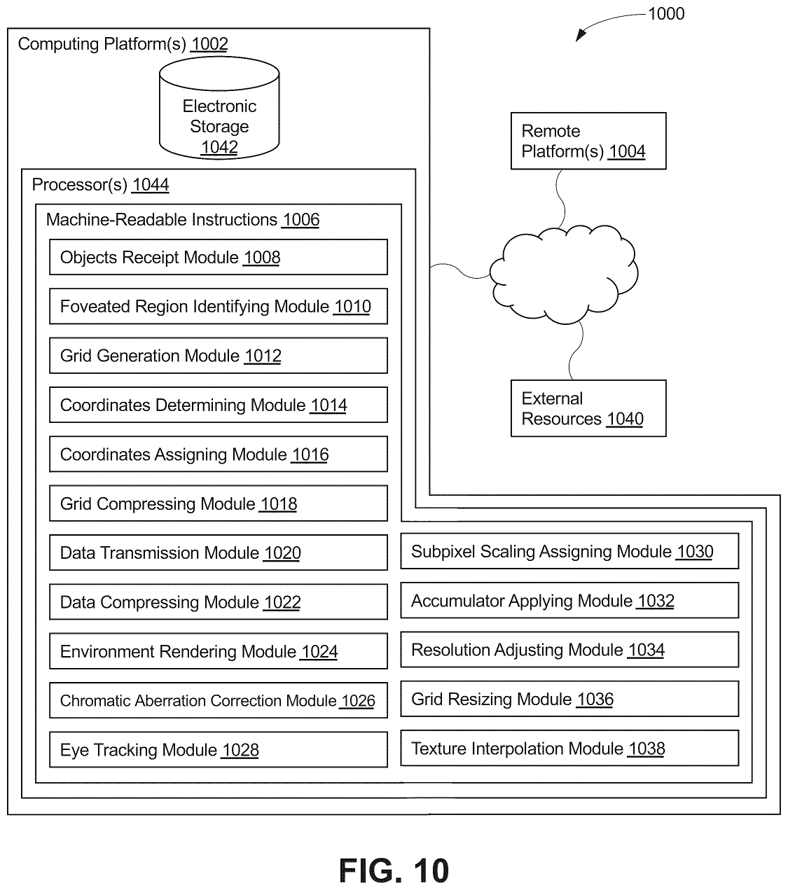

FIG. 10 illustrates a system 1000 configured for rendering images, according to certain aspects of the disclosure. In some embodiments, system 1000 may include one or more computing platforms 1002. Computing platform(s) 1002 may be configured to communicate with one or more remote platforms 1004 according to a client/server architecture, a peer-to-peer architecture, and/or other architectures. Remote platform(s) 1004 may be configured to communicate with other remote platforms via computing platform(s) 1002 and/or according to a client/server architecture, a peer-to-peer architecture, and/or other architectures. Users may access system 1000 via remote platform(s) 1004.

Computing platform(s) 1002 may be configured by machine-readable instructions 1006. Machine-readable instructions 1006 may include one or more instruction modules. The instruction modules may include computer program modules. The instruction modules may include one or more of a objects receipt module 1008, foveated region identifying module 1010, grid generation module 1012, coordinates determining module 1014, coordinates assigning module 1016, grid compressing module 1018, data transmission module 1020, data decompressing module 1022, environment rendering module 1024, chromatic aberration correction module 1026, eye tracking module 1028, subpixel scaling assigning module 1030, accumulator applying module 1032, resolution adjusting module 1034, grid resizing module 1036, texture interpolation module 1038, and/or other modules.

Objects receipt module 1008 may be configured to receive a plurality of objects in an area of interest of a mixed environment.

Foveated region identifying module 1010 may be configured to identify a foveated region.

Grid generation module 1012 may be configured to generate a grid in proximity to the foveated region. The grid may include a plurality of intersecting vertical and horizontal lines.

Coordinates determining module 1014 may be configured to determine a plurality of coordinates. Each coordinate of the plurality of coordinates may be defined based on a spatial orientation in the grid.

Coordinates assigning module 1016 may be configured to assign the plurality of coordinates to the plurality of objects in the area of interest.

Grid compressing module 1018 may be configured to compress a portion of the grid external to the foveated region and data associated with the plurality of objects covered by the portion of the grid external to the foveated region.

Data transmission module 1020 may be configured to transmit the foveated region, compressed coordinate data and compressed object data.

Data decompressing module 1022 may be configured to decompress the compressed coordinate data and compressed object data.

Environment rendering module 1024 may be configured to render an environment associated with the area of interest using the foveated image and object data external to the foveated image. Rendering the environment may include adjusting the brightness and contrast of the decompressed object data to align with the user's perceived environment lighting conditions.

Chromatic aberration correction module 1026 may be configured to implement a chromatic aberration correction protocol to the compressed coordinate data and compressed object data. The chromatic aberration correction protocol may separate color components into size ratios in relation to the chromatic frequency associated with the respective color component. The chromatic aberration correction protocol may also be applied to the decompressed coordinate data and decompressed object data, wherein the correction protocol separates color components into size ratios relative to their chromatic frequencies.

Eye tracking module 1028 may be configured to track the user's eye movements to dynamically update the foveated region in response to changes in the user's gaze within the mixed reality environment. The foveated image may be determined based on an eye tracking protocol.

Subpixel scaling assigning module 1030 may be configured to assign discrete subpixel scaling parameters to each subgrid within the grid to enhance the accuracy of the rendered environment associated with the area of interest.

Accumulator applying module 1032 may be configured to apply an accumulator at the ends of zones within the grid to minimize rounding errors during the decompression of the compressed coordinate data and compressed object data.

Resolution adjusting module 1034 may be configured to adjust the resolution of the grid external to the foveated region to reduce the power consumption and system on chip (SoC) double data rate (DDR) bandwidth during the rendering process.

Grid resizing module 1036 may be configured to dynamically resize the grid in response to the processing capabilities of the mixed reality system, allowing for adaptive resolution changes. The grid may include a plurality of zones, each zone having associated therewith a distinct compression ratio based on the distance from the foveated region.

Texture interpolation module 1038 may be configured to decompress the compressed object data, which includes texture information, and involve texture interpolation to maintain visual fidelity.

In some embodiments, computing platform(s) 1002, remote platform(s) 1004, and/or external resources 1040 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which computing platform(s) 1002, remote platform(s) 1004, and/or external resources 1040 may be operatively linked via some other communication media.

A given remote platform 1004 may include one or more processors configured to execute computer program modules. The computer program modules may be configured to enable an expert or user associated with the given remote platform 1004 to interface with system 1000 and/or external resources 1040, and/or provide other functionality attributed herein to remote platform(s) 1004. By way of non-limiting example, a given remote platform 1004 and/or a given computing platform 1002 may include one or more of a server, a desktop computer, a laptop computer, a handheld computer, a tablet computing platform, a NetBook, a Smartphone, a gaming console, and/or other computing platforms.

External resources 1040 may include sources of information outside of system 1000, external entities participating with system 1000, and/or other resources. In some embodiments, some or all of the functionality attributed herein to external resources 1040 may be provided by resources included in system 1000.

Computing platform(s) 1002 may include electronic storage 1042, one or more processors 1044, and/or other components. Computing platform(s) 1002 may include communication lines, or ports to enable the exchange of information with a network and/or other computing platforms. Illustration of computing platform(s) 1002 in FIG. 10 is not intended to be limiting. Computing platform(s) 1002 may include a plurality of hardware, software, and/or firmware components operating together to provide the functionality attributed herein to computing platform(s) 1002. For example, computing platform(s) 1002 may be implemented by a cloud of computing platforms operating together as computing platform(s) 1002.

Electronic storage 1042 may comprise non-transitory storage media that electronically stores information. The electronic storage media of electronic storage 1042 may include one or both of system storage that is provided integrally (i.e., substantially non-removable) with computing platform(s) 1002 and/or removable storage that is removably connectable to computing platform(s) 1002 via, for example, a port (e.g., a USB port, a firewire port, etc.) or a drive (e.g., a disk drive, etc.). Electronic storage 1042 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 1042 may include one or more virtual storage resources (e.g., cloud storage, a virtual private network, and/or other virtual storage resources). Electronic storage 1042 may store software algorithms, information determined by processor(s) 1044, information received from computing platform(s) 1002, information received from remote platform(s) 1004, and/or other information that enables computing platform(s) 1002 to function as described herein.

Processor(s) 1044 may be configured to provide information processing capabilities in computing platform(s) 1002. As such, processor(s) 1044 may include one or more of a digital processor, an analog processor, a digital circuit designed to process information, an analog circuit designed to process information, a state machine, and/or other mechanisms for electronically processing information. Although processor(s) 1044 is shown in FIG. 10 as a single entity, this is for illustrative purposes only. In some embodiments, processor(s) 1044 may include a plurality of processing units. These processing units may be physically located within the same device, or processor(s) 1044 may represent processing functionality of a plurality of devices operating in coordination. Processor(s) 1044 may be configured to execute modules 1008, 1010, 1012, 1014, 1016, 1018, 1020, 1022, 1024, 1026, 1028, 1030, 1032, 1034, 1036, and/or 1038, and/or other modules. Processor(s) 1044 may be configured to execute modules 1008, 1010, 1012, 1014, 1016, 1018, 1020, 1022, 1024, 1026, 1028, 1030, 1032, 1034, 1036, and/or 1038, and/or other modules by software; hardware; firmware; some combination of software, hardware, and/or firmware; and/or other mechanisms for configuring processing capabilities on processor(s) 1044. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 1008, 1010, 1012, 1014, 1016, 1018, 1020, 1022, 1024, 1026, 1028, 1030, 1032, 1034, 1036, and/or 1038 are illustrated in FIG. 10 as being implemented within a single processing unit, in embodiments in which processor(s) 1044 includes multiple processing units, one or more of modules 1008, 1010, 1012, 1014, 1016, 1018, 1020, 1022, 1024, 1026, 1028, 1030, 1032, 1034, 1036, and/or 1038 may be implemented remotely from the other modules. The description of the functionality provided by the different modules 1008, 1010, 1012, 1014, 1016, 1018, 1020, 1022, 1024, 1026, 1028, 1030, 1032, 1034, 1036, and/or 1038 described below is for illustrative purposes, and is not intended to be limiting, as any of modules 1008, 1010, 1012, 1014, 1016, 1018, 1020, 1022, 1024, 1026, 1028, 1030, 1032, 1034, 1036, and/or 1038 may provide more or less functionality than is described. For example, one or more of modules 1008, 1010, 1012, 1014, 1016, 1018, 1020, 1022, 1024, 1026, 1028, 1030, 1032, 1034, 1036, and/or 1038 may be eliminated, and some or all of its functionality may be provided by other ones of modules 1008, 1010, 1012, 1014, 1016, 1018, 1020, 1022, 1024, 1026, 1028, 1030, 1032, 1034, 1036, and/or 1038. As another example, processor(s) 1044 may be configured to execute one or more additional modules that may perform some or all of the functionality attributed below to one of modules 1008, 1010, 1012, 1014, 1016, 1018, 1020, 1022, 1024, 1026, 1028, 1030, 1032, 1034, 1036, and/or 1038.

The techniques described herein may be implemented as method(s) that are performed by physical computing device(s); as one or more non-transitory computer-readable storage media storing instructions which, when executed by computing device(s), cause performance of the method(s); or, as physical computing device(s) that are specially configured with a combination of hardware and software that causes performance of the method(s).

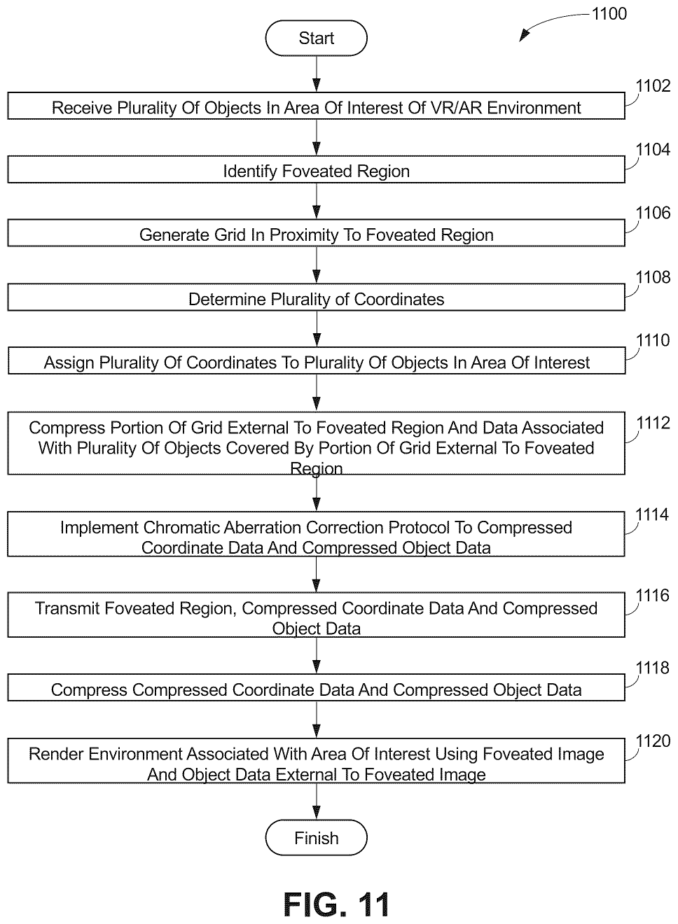

FIG. 11 illustrates an example flow diagram (e.g., process 1100) for rendering images, according to certain aspects of the disclosure. For explanatory purposes, the example process 1100 is described herein with reference to FIGS. 1-10. Further for explanatory purposes, the operations of the example process 1100 are described herein as occurring in serial, or linearly. However, multiple instances of the example process 1100 may occur in parallel. For purposes of explanation of the subject technology, the process 1100 will be discussed in reference to FIGS. 1-10.

An operation 1102 may include receiving a plurality of objects in an area of interest of a mixed reality environment. Operation 1102 may be performed by one or more hardware processors configured by machine-readable instructions including a module that is the same as or similar to objects receipt module 1008, in accordance with one or more embodiments.

An operation 1104 may include identifying a foveated region. Operation 1104 may be performed by one or more hardware processors configured by machine-readable instructions including a module that is the same as or similar to foveated region identifying module 1010, in accordance with one or more embodiments.

An operation 1106 may include generating a grid in proximity to the foveated region, wherein the grid comprises a plurality of intersecting vertical and horizontal lines. Operation 1106 may be performed by one or more hardware processors configured by machine-readable instructions including a module that is the same as or similar to grid generation module 1012, in accordance with one or more embodiments.

An operation 1108 may include determining a plurality of coordinates, wherein each coordinate of the plurality of coordinates is defined based on a spatial orientation in the grid. Operation 1108 may be performed by one or more hardware processors configured by machine-readable instructions including a module that is the same as or similar to coordinates determining module 1014, in accordance with one or more embodiments.

An operation 1110 may include assigning the plurality of coordinates to the plurality of objects in the area of interest. Operation 1110 may be performed by one or more hardware processors configured by machine-readable instructions including a module that is the same as or similar to coordinates assigning module 1016, in accordance with one or more embodiments.

An operation 1112 may include compressing a portion of the grid external to the foveated region and data associated with the plurality of objects covered by the portion of the grid external to the foveated region. Operation 1112 may be performed by one or more hardware processors configured by machine-readable instructions including a module that is the same as or similar to grid compressing module 1018, in accordance with one or more embodiments.

An operation 1114 may include implementing a chromatic aberration correction protocol to the compressed coordinate data and compressed object data. The chromatic aberration correction may separate to color components into size ratios in relation to the chromatic frequency associated with the respective color component. Operation 1114 may be performed by one or more hardware processors configured by machine-readable instructions including a module that is the same as or similar to chromatic aberration correction module 1026, in accordance with one or more embodiments.

An operation 1116 may include transmitting the foveated region, compressed coordinate data and compressed object data. Operation 1116 may be performed by one or more hardware processors configured by machine-readable instructions including a module that is the same as or similar to data transmission module 1020, in accordance with one or more embodiments.

An operation 1118 may include decompressing the compressed coordinate data and compressed object data. Operation 1118 may be performed by one or more hardware processors configured by machine-readable instructions including a module that is the same as or similar to data decompressing module 1022, in accordance with one or more embodiments.

An operation 1120 may include rendering an environment associated with the area of interest using the foveated image and object data external to the foveated image. Operation 1120 may be performed by one or more hardware processors configured by machine-readable instructions including a module that is the same as or similar to environment rendering module 1024, in accordance with one or more embodiments.

According to an aspect, the foveated image is determined based on an eye tracking protocol.

According to an aspect, the process 1100 may include applying a chromatic aberration correction protocol to the decompressed coordinate data and decompressed object data, wherein the correction protocol separates color components into size ratios relative to their chromatic frequencies.

According to an aspect, the process 1100 may include tracking the user's eye movements to dynamically update the foveated region in response to changes in the user's gaze within the mixed reality environment.

According to an aspect, the process 1100 may include assigning discrete subpixel scaling parameters to each subgrid within the grid to enhance the accuracy of the rendered environment associated with the area of interest.

According to an aspect, the process 1100 may include applying an accumulator at the ends of zones within the grid to minimize rounding errors during the decompression of the compressed coordinate data and compressed object data.

According to an aspect, the process 1100 may include adjusting the resolution of the grid external to the foveated region to reduce the power consumption and system on chip (SoC) double data rate (DDR) bandwidth during the rendering process.

According to an aspect, the grid is dynamically resizable in response to the processing capabilities of the mixed reality system, allowing for adaptive resolution changes.

According to an aspect, the compressed object data includes texture information, and the decompression of the compressed object data involves texture interpolation to maintain visual fidelity.

According to an aspect, the grid comprises a plurality of zones, each zone having associated therewith a distinct compression ratio based on the distance from the foveated region.

According to an aspect, the rendering includes adjusting the brightness and contrast of the decompressed object data to align with the user's perceived environment lighting conditions.

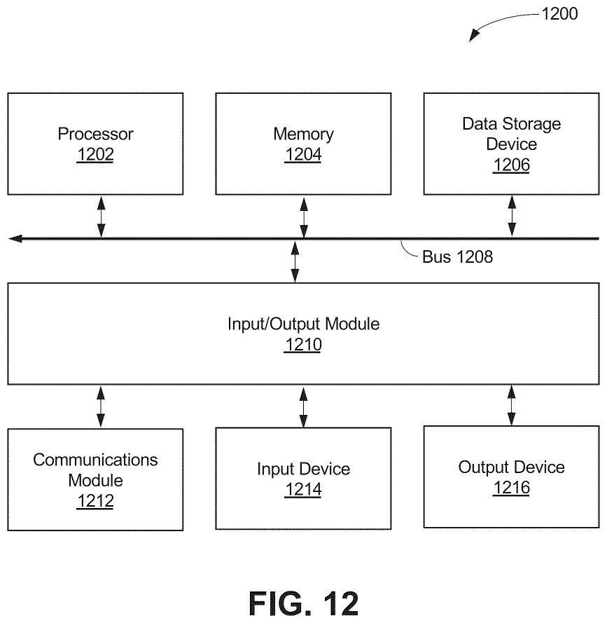

FIG. 12 is a block diagram illustrating an exemplary computer system 1200 with which aspects of the subject technology can be implemented. In certain aspects, the computer system 1200 may be implemented using hardware or a combination of software and hardware, either in a dedicated server, integrated into another entity, or distributed across multiple entities.

Computer system 1200 (e.g., server and/or client) includes a bus 1208 or other communication mechanism for communicating information, and a processor 1202 coupled with bus 1208 for processing information. By way of example, the computer system 1200 may be implemented with one or more processors 1202. Processor 1202 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 1200 can include, in addition to hardware, code that creates an execution environment for the computer program in question, e.g., code that constitutes processor firmware, a protocol stack, a database management system, an operating system, or a combination of one or more of them stored in an included memory 1204, such as a Random Access Memory (RAM), a flash memory, a Read-Only Memory (ROM), a Programmable Read-Only Memory (PROM), an Erasable PROM (EPROM), registers, a hard disk, a removable disk, a CD-ROM, a DVD, or any other suitable storage device, coupled to bus 1208 for storing information and instructions to be executed by processor 1202. The processor 1202 and the memory 1204 can be supplemented by, or incorporated in, special purpose logic circuitry.

The instructions may be stored in the memory 1204 and implemented in one or more computer program products, i.e., one or more modules of computer program instructions encoded on a computer-readable medium for execution by, or to control the operation of, the computer system 1200, and according to any method well-known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, and xml-based languages. Memory 1204 may also be used for storing temporary variable or other intermediate information during execution of instructions to be executed by processor 1202.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 1200 further includes a data storage device 1206 such as a magnetic disk or optical disk, coupled to bus 1208 for storing information and instructions. Computer system 1200 may be coupled via input/output module 1210 to various devices. The input/output module 1210 can be any input/output module. Exemplary input/output modules 1210 include data ports such as USB ports. The input/output module 1210 is configured to connect to a communications module 1212. Exemplary communications modules 1212 include networking interface cards, such as Ethernet cards and modems. In certain aspects, the input/output module 1210 is configured to connect to a plurality of devices, such as an input device 1214 and/or an output device 1216. Exemplary input devices 1214 include a keyboard and a pointing device, e.g., a mouse or a trackball, by which a user can provide input to the computer system 1200. Other kinds of input devices 1214 can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback, and input from the user can be received in any form, including acoustic, speech, tactile, or brain wave input. Exemplary output devices 1216 include display devices such as an LCD (liquid crystal display) monitor, for displaying information to the user.

According to one aspect of the present disclosure, the above-described gaming systems can be implemented using a computer system 1200 in response to processor 1202 executing one or more sequences of one or more instructions contained in memory 1204. Such instructions may be read into memory 1204 from another machine-readable medium, such as data storage device 1206. Execution of the sequences of instructions contained in the main memory 1204 causes processor 1202 to perform the process steps described herein. One or more processors in a multi-processing arrangement may also be employed to execute the sequences of instructions contained in memory 1204. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., such as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. The communication network can include, for example, any one or more of a LAN, a WAN, the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

Computer system 1200 can include clients and servers. A client and server are generally remote from each other and typically interact through a communication network. The relationship of client and server arises by virtue of computer programs running on the respective computers and having a client-server relationship to each other. Computer system 1200 can be, for example, and without limitation, a desktop computer, laptop computer, or tablet computer. Computer system 1200 can also be embedded in another device, for example, and without limitation, a mobile telephone, a PDA, a mobile audio player, a Global Positioning System (GPS) receiver, a video game console, and/or a television set top box.

The term “machine-readable storage medium” or “computer-readable medium” as used herein refers to any medium or media that participates in providing instructions to processor 1202 for execution. Such a medium may take many forms, including, but not limited to, non-volatile media, volatile media, and transmission media. Non-volatile media include, for example, optical or magnetic disks, such as data storage device 1206. Volatile media include dynamic memory, such as memory 1204. Transmission media include coaxial cables, copper wire, and fiber optics, including the wires that comprise bus 1208. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter effecting a machine-readable propagated signal, or a combination of one or more of them.

As the user computing system 1200 reads game data and provides a game, information may be read from the game data and stored in a memory device, such as the memory 1204. Additionally, data from the memory 1204 servers accessed via a network the bus 1208, or the data storage 1206 may be read and loaded into the memory 1204. Although data is described as being found in the memory 1204, it will be understood that data does not have to be stored in the memory 1204 and may be stored in other memory accessible to the processor 1202 or distributed among several media, such as the data storage 1206.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

To the extent that the terms “include,” “have,” or the like is used in the description or the claims, such term is intended to be inclusive in a manner similar to the term “comprise” as “comprise” is interpreted when employed as a transitional word in a claim. The word “exemplary” is used herein to mean “serving as an example, instance, or illustration.” Any embodiment described herein as “exemplary” is not necessarily to be construed as preferred or advantageous over other embodiments.

A reference to an element in the singular is not intended to mean “one and only one” unless specifically stated, but rather “one or more.” All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products. Other variations are within the scope of the following claims.

What is claimed is:

1. A computer-implemented method for rendering an image, the method comprising:
receiving a plurality of objects in an area of interest of a mixed reality environment;
identifying a foveated region;
generating a grid in proximity to the foveated region, wherein the grid comprises a plurality of intersecting vertical and horizontal lines;
determining a plurality of coordinates, wherein each coordinate of the plurality of coordinates is defined based on a spatial orientation in the grid;
assigning the plurality of coordinates to the plurality of objects in the area of interest;
compressing a portion of the grid external to the foveated region and data associated with the plurality of objects covered by the portion of the grid external to the foveated region;
implementing a chromatic aberration correction protocol to the compressed coordinate data and compressed object data, wherein chromatic aberration correction separates to color components into size ratios in relation to a chromatic frequency associated with the respective color component;
transmitting the foveated region, compressed coordinate data and compressed object data;
decompressing the compressed coordinate data and compressed object data; and
rendering an environment associated with the area of interest using a foveated image and object data external to the foveated image.

2. The method of claim 1, wherein the foveated image is determined based on an eye tracking protocol.

3. The method of claim 1, further comprising applying a chromatic aberration correction protocol to the decompressed coordinate data and decompressed object data, wherein the correction protocol separates color components into size ratios relative to their chromatic frequencies.

4. The method of claim 1, further comprising tracking a user's eye movements to dynamically update the foveated region in response to changes in a user's gaze within the mixed reality environment.

5. The method of claim 1, further comprising assigning discrete subpixel scaling parameters to each subgrid within the grid to enhance accuracy of the rendered environment associated with the area of interest.

6. The method of claim 1, further comprising applying an accumulator to at least one end of zones within the grid to minimize rounding errors during the decompression of the compressed coordinate data and compressed object data.

7. The method of claim 1, further comprising adjusting a resolution of the grid external to the foveated region to reduce power consumption and system on chip (SoC) double data rate (DDR) bandwidth during a rendering process.

8. The method of claim 1, wherein the grid is dynamically resizable in response to processing capabilities of a mixed reality system, allowing for adaptive resolution changes.

9. The method of claim 1, wherein the compressed object data includes texture information, and the decompression of the compressed object data involves texture interpolation to maintain visual fidelity.

10. The method of claim 1, wherein the grid comprises a plurality of zones, each zone having associated therewith a distinct compression ratio based on a distance from the foveated region.

11. The method of claim 1, wherein the rendering includes adjusting brightness and contrast of decompressed object data to align with a user's perceived environment lighting conditions.

12. A system configured for rendering an image, a computing platform comprising:
a non-transient computer-readable storage medium having executable instructions embodied thereon; and
one or more hardware processors configured to execute the instructions to:
receive a plurality of objects in an area of interest of a mixed reality environment;
identify a foveated region;
generate a grid in proximity to the foveated region, wherein the grid comprises a plurality of intersecting vertical and horizontal lines;
determine a plurality of coordinates, wherein each coordinate of the plurality of coordinates is defined based on a spatial orientation in the grid;
assign the plurality of coordinates to the plurality of objects in the area of interest;
compress a portion of the grid external to the foveated region and data associated with the plurality of objects covered by the portion of the grid external to the foveated region;
implement a chromatic aberration correction protocol to the compressed coordinate data and compressed object data, wherein chromatic aberration correction separates color components into size ratios in relation to a chromatic frequency associated with the respective color component;
transmit the foveated region, compressed coordinate data and compressed object data;
decompress the compressed coordinate data and compressed object data; and
render an environment associated with the area of interest using a foveated image and object data external to the foveated image.

13. The system of claim 12, wherein the foveated image is determined based on an eye tracking protocol.

14. The system of claim 12, wherein the one or more hardware processors are further configured by the instructions to:
apply a chromatic aberration correction protocol to the decompressed coordinate data and decompressed object data, wherein the correction protocol separates color components into size ratios relative to their chromatic frequencies.

15. The system of claim 12, wherein the one or more hardware processors are further configured by the instructions to:
track a user's eye movements to dynamically update the foveated region in response to changes in a user's gaze within the mixed reality environment.

16. The system of claim 12, wherein the one or more hardware processors are further configured by the instructions to:
assign discrete subpixel scaling parameters to each subgrid within the grid to enhance accuracy of the rendered environment associated with the area of interest.

17. The system of claim 12, wherein the one or more hardware processors are further configured by the instructions to:
apply an accumulator to at least one end of zones within the grid to minimize rounding errors during the decompression of the compressed coordinate data and compressed object data.

18. The system of claim 12, wherein the one or more hardware processors are further configured by the instructions to:
adjusting resolution of the grid external to the foveated region to reduce power consumption and system on chip (SoC) double data rate (DDR) bandwidth during a rendering process.

19. The system of claim 12, wherein the grid is dynamically resizable in response to processing capabilities of a mixed reality system, allowing for adaptive resolution changes.

20. A non-transient computer-readable storage medium having instructions embodied thereon, the instructions being executable by one or more processors to perform a method for rendering an image, the method comprising:
receiving a plurality of objects in an area of interest of a mixed reality environment;
identifying a foveated region;
generating a grid in proximity to the foveated region, wherein the grid comprises a plurality of intersecting vertical and horizontal lines;
determining a plurality of coordinates, wherein each coordinate of the plurality of coordinates is defined based on a spatial orientation in the grid;
assigning the plurality of coordinates to the plurality of objects in the area of interest;
compressing a portion of the grid external to the foveated region and data associated with the plurality of objects covered by the portion of the grid external to the foveated region;
implementing a chromatic aberration correction protocol to the compressed coordinate data and compressed object data, wherein chromatic aberration correction separates to color components into size ratios in relation to a chromatic frequency associated with the respective color component;
transmitting the foveated region, compressed coordinate data and compressed object data;
decompressing the compressed coordinate data and compressed object data; and
rendering an environment associated with the area of interest using a foveated image and object data external to the foveated image.
